(19) United States
(12) Patent Application Publication
(10) Pub. No.: US 2025/0067913 A1
(43) Pub. Date: Feb. 27, 2025

(54) COMPOSITE FILM LAYER CAPABLE OF TRANSMITTING WHITE LIGHT, PREPARATION METHOD THEREFOR AND APPLICATION

(71) Applicant: NINGBO SHINTAI MACHINES CO., LTD., Ningbo, Zhejiang (CN)

(72) Inventors: Jianqiu Zuo, Ningbo, Zhejiang (CN); Xiaofeng Yang, Ningbo, Zhejiang (CN); Xianglin FU, Ningbo, Zhejiang (CN); Lin Luo, Ningbo, Zhejiang (CN); Guoqiang Ye, Ningbo, Zhejiang (CN)

(21) Appl. No.: 18/724,682

(22) PCT Filed: Jan. 7, 2022
(86) PCT No.: PCT/CN2022/070771

§ 371 Date: Jun. 27, 2024

(30) Foreign Application Priority Data
Dec. 28, 2021 (CN) 202111622494.3

(51) Int. Cl. G02B 5/22

(52) U.S. Cl. CPC G02B 5/22

(57) ABSTRACT

A composite film layer capable of transmitting white light comprises a transparent panel and an indium plating layer, wherein the transparent panel is closer to a white light source relative to the indium plating layer; and the transparent panel is formed by mixing transparent plastics and a blue pigment and performing injection moulding, or is formed by mixing transparent plastics, a blue pigment and a purple pigment and performing injection moulding. The transparent panel containing the blue pigment or containing the blue pigment and the purple pigment is attached to one side of the indium plating layer by using the principle of complementary colours in chromatics, so that the composite film layer can transmit white light, and a colour temperature value of the transmitted white light is 5200 to 7200 K.

### TECHNICAL FIELD

The invention belongs to the technical field of luminescence, and relates to a composite film layer capable of transmitting white light, a preparation method therefor and an application.

### DESCRIPTION OF RELATED ART

With the development of the automotive industry towards energy conservation, environmental protection and intelligence, vehicle-mounted luminous wave-transmitting products, such as luminous grilles, luminous signs and luminous interior and exterior trims, will become increasingly popular, wherein the luminous grilles and luminous signs are required to transmit white light, and some of the luminous products are integrated with radar to assist in driving. Existing products capable of transmitting white light are formed by a transparent product sprayed with white paint of a certain thickness and a backlight base plate capable of transmitting white light. When a light is turned on, the product transmits white light seen from the front. However, when the light is turned off, the light-transmitting area of the product only shows an ordinary white colour, lacks the high-end metal-plated silver texture and cannot satisfy the appearance requirement of high-end luminous products. By means of the physical vapor deposition (PVD) indium plating process, the light-transmitting area of the product can show a good metal sliver texture seen from the front when the light is turned off. However, when the product is used together with a backlight base plate capable of transmitting white light, the transmitted light is yellow obviously, and the colour temperature of the transmitted light is lower than 4500 K, thus failing to satisfy the requirements for white light transmission of products and the colour temperature from 5200 to 7200K of transmitted light. No matter how to adjust the thickness of a PVD indium plating layer, the vacuum degree of plating, the position of an evaporation source (tungsten filaments), the number of the tungsten filaments, and parameters of evaporation plating, the PVD indium plating layer cannot transmit white light.

### BRIEF SUMMARY OF THE INVENTION

In view of the defects in the prior art, the invention attaches a transparent panel containing a blue pigment or containing a blue pigment and a purple pigment to one side of an indium plating layer by using the principle of complementary colours in chromatics, so that a composite film layer can transmit white light, and a colour temperature value of transmitted white light is 5200 to 7200 K.

In one aspect, the invention provides a composite film layer capable of transmitting white light, comprising a transparent panel and an indium plating layer, wherein the transparent panel is closer to a white light source relative to the indium plating layer;
the transparent panel is formed by mixing transparent plastics and a blue pigment and performing injection moulding.

Preferably, the mass of the blue pigment is 0.5-8% of the mass of the transparent plastics.

Preferably, the transparent panel is formed by mixing transparent plastics, a blue pigment and a purple pigment and performing injection moulding.

Preferably, the mass of the blue pigment is 0.5-8% of the mass of the transparent plastics, and the mass of the purple pigment is greater than 0% and less than or equal to 2% of the mass of the transparent plastics.

Preferably, an average particle size of the blue pigment and the purple pigment is 0.15 to 1.5 μm.

Preferably, a CMYK value of the blue pigment is one or more selected from:
C35 M0 Y20 K0, C40 M0 Y10 K0, C60 M0 Y10 K0, C70 M10 Y0 K0, C45 M10 Y10 K0, C30 M0 Y10 K10, C40 M10 Y0 K20, C60 M15 Y0 K30, C75 M30 Y10 K15, C80 M10 Y20 K0, C95 M25 Y45 K0, C100 M50 Y45 K0, C100 M35 Y10 K0, C95 M60 Y0 K0, C100 M80 Y0 K0, and C90 M70 Y0 K0;
a CMYK value of the purple pigment is one or more selecting from:
C55 M85 Y0 K0, C45 M70 Y50 K0, and C60 M95 Y95 K20.

Preferably, the composite film layer capable of transmitting white light sequentially comprises the transparent panel, the indium plating layer and a transparent coating layer.

Preferably, a thickness of the transparent panel, a thickness of the indium plating layer and a thickness of the transparent coating layer are 1 to 10 mm, 15 to 50 nm and 15 to 30 μm respectively.

Preferably, the composite film layer capable of transmitting white light sequentially comprises the transparent panel, a transparent priming layer, the indium plating layer and a transparent coating layer.

Preferably, a thickness of the transparent panel, a thickness of the transparent priming layer, a thickness of the indium plating layer and a thickness of the transparent coating layer are 1 to 10 mm, 15 to 30 μm, 15 to 50 nm and 15 to 30 μm respectively.

Preferably, when the white light source illuminates the composite film layer capable of transmitting white light, colour coordinates of transmitted light are within a range defined by six colour coordinate lines: A (0.310, 0.348), B (0.453, 0.440), C (0.500, 0.440), D (0.500, 0.382), E (0.443, 0.382), and F (0.310, 0.283),
and a colour temperature value of the transmitted light is 5200 to 7200 K.

Preferably, when the white light source illuminates the composite film layer capable of transmitting white light, colour coordinates of transmitted light are within a range defined by six colour coordinate lines: A (0.310, 0.348), B (0.453, 0.440), C (0.500, 0.440), D (0.500, 0.382), E (0.443, 0.382), and F (0.310, 0.283),
and a colour temperature value of the transmitted light is 5500 to 7000 K.

In another aspect, the invention provides a preparation method for the composite film layer capable of transmitting white light, comprising the following steps:
mixing transparent plastics and a blue pigment, and performing injection moulding to form a transparent panel;
coating a side of the transparent panel with a transparent priming paste to form a transparent priming layer;
forming an indium plating layer on the transparent priming layer by PVD evaporation indium plating; and
coating the indium plating layer with a transparent coating to form a transparent coating layer, thus obtaining the composite film layer capable of transmitting white light.

In a third aspect, the invention provides a luminous device, comprising a white light source and the composite film layer capable of transmitting white light, wherein the transparent panel in the composite film layer capable of transmitting white light is closer to the white light source relative to the indium plating layer, and after white light emitted by the white light source passes through the composite film layer capable of transmitting white light, colour coordinates of transmitted light are within a range defined by six colour coordinate lines:
A (0.310, 0.348), B (0.453, 0.440), C (0.500, 0.440), D (0.500, 0.382), E (0.443, 0.382), and F (0.310, 0.283),
and a colour temperature value of the transmitted light is 5200 to 7200 K.

The luminous device, for example, may be a vehicle-mounted luminous grille, a luminous sign, a luminous trim, or the like.

Compared with the prior art, the invention has the following beneficial effects:
1. In the invention, the transparent panel containing the blue pigment or containing the blue pigment and the purple pigment is attached to one side of the indium plating layer, so that the composite film layer can transmit white light by means of colour complementation, and the colour temperature can reach 5200 to 7200 K;
2. In the invention, the transparent panel is located on the back side of the indium plating layer, and in a case where a white light source is not turned on, observers can still see the metal texture of a light-transmitting area of the composite film layer from the front, so that the composite film layer provided by the invention not only can transmit pure white light, but also can satisfy the requirement for a metal-colour appearance;
3. The composite film layer capable of transmitting white light provided by the invention can have various structures as long as the transparent panel is located on the back side of the indium plating layer, and the actual structure of the composite film layer capable of transmitting white light can be adjusted according to actual product demands;
4. The composite film layer capable of transmitting white light provided by the invention can be applied to luminous devices such as vehicle-mounted luminous grilles, luminous signs, luminous interior and exterior trims to ensure that the luminous devices can transmit white light and have a metal-colour appearance.

### BRIEF DESCRIPTION OF THE SEVERAL VIEWS OF THE DRAWINGS

FIG. 1 illustrates the range of colour coordinates of white light;

FIG. 2 illustrates a first structure of a composite film layer capable of transmitting white light according to the invention;

FIG. 3 illustrates a second structure of the composite film layer capable of transmitting white light according to the invention;

FIG. 4 is a schematic structural view of a luminous device according to the invention;

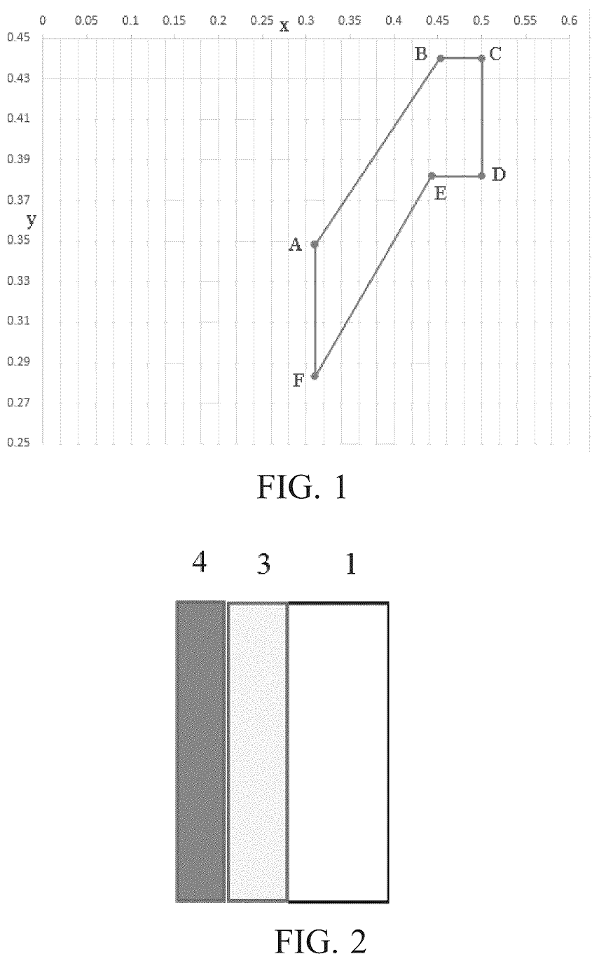

In the FIGS. 1, transparent panel; 2, transparent priming layer; 3, indium plating layer; 4, transparent coating layer; 5, white light source.

### DETAILED DESCRIPTION OF THE INVENTION

Embodiments of a composite film layer capable of transmitting white light and a preparation method therefor provided by the invention are described in detail below. These embodiments are illustrative, and the contents disclosed by the invention are not limited to these embodiments. Drawings used here are merely for better explaining the contents disclosed by the invention and are not intended to limit the protection scope of the invention.

A transparent or semitransparent object can transmit light, wherein part of the light irradiated onto the transparent or semitransparent object is absorbed by the object, and the other part of the light passes through the object. The part of light absorbed by the object cannot be seen, while the part of light passes through the object can be seen by human eyes. Different objects can transmit light in different colours, so the colour of transparent objects is determined by light passing through the objects. The primary cause of a yellow colour of transmitted light is the structural characteristics of a PVD indium plating film.

Based on the above principle, in the invention, a transparent panel containing a blue pigment or containing a blue pigment and a purple pigment is attached to the back side of an indium plating layer (the back side of the indium plating layer is defined as a side, close to a white light source, of the indium plating layer), so that the problem of a yellow colour caused by absorption of part of light of the indium plating layer is solved by means of colour complementation of the indium plating layer and the transparent panel, and the light colour is harmonized to allow a product to transmit white light.

In some embodiments of the invention, the composite film layer capable of transmitting white light comprises a transparent panel and an indium plating layer, wherein the transparent panel is formed by mixing transparent plastics and a blue pigment and performing injection moulding, or the transparent panel is formed by mixing transparent plastics, a blue pigment and a purple pigment and performing injection moulding.

Wherein, the transparent panel in the composite film layer capable of transmitting white light is closer to a white light source relative to the indium plating layer, white light emitted by the white light source sequentially passes through the transparent panel and the indium plating layer, and after the white light passes through the composite film layer capable of transmitting white light, colour coordinates of transmitted light are within a range defined by six colour coordinate lines:
A (0.310, 0.348), B (0.453, 0.440), C (0.500, 0.440), D (0.500, 0.382), E (0.443, 0.382), and F (0.310, 0.283), as shown in FIG. 1, an area defined by the six colour coordinate lines is the range of the colour coordinates of the white light;
and a colour temperature value of the transmitted light is 5200 to 7200 K.
A CMYK value of the blue pigment in the transparent panel is one or more selected from: C35 M0 Y20 K0, C40 M0 Y10 K0, C60 M0 Y10 K0, C70 M10 Y0 K0, C45 M10 Y10 K0, C30 M0 Y10 K10, C40 M10 Y0 K20, C60 M15 Y0 K30, C75 M30 Y10 K15, C80 M10 Y20 K0, C95 M25 Y45 K0, C100 M50 Y45 K0, C100 M35 Y10 K0, C95 M60 Y0 K0, C100 M80 Y0 K0, and C90 M70 Y0 K0;
a CMYK value of the purple pigment in the transparent panel is one or more selected from: C55 M85 Y0 K0, C45 M70 Y50 K0, and C60 M95 Y95 K20.

An average particle size of the blue pigment and the purple pigment is 0.15 to 1.5 μm.

The specific proportion of the blue pigment and the blue pigment added to the transparent panel depends on the selected CMYK value and particle size of the blue pigment and the purple pigment and the thickness of the indium plating layer. Preferably, the mass of the blue pigment is 0.5-8% of the mass of the transparent plastics, and the mass of the purple pigment is 0-2% of the mass of the transparent plastics.

In some other embodiments of the invention, the composite film layer capable of transmitting white light, as shown in FIG. 2, sequentially comprises a transparent panel 1, an indium plating layer 3 and a transparent coating layer 4, wherein the transparent panel 1 is closer to a white light source relative to the indium plating layer 3, and white light emitted by the white light source sequentially passes through the transparent panel 1, the indium plating layer 3 and the transparent coating layer 4.

The thickness of the transparent panel 1, the thickness of the indium plating layer 3 and the thickness of the transparent coating layer 4 are 1 to 10 mm, 15 to 50 nm and 15 to 30 μm respectively.

The preparation method for the composite film layer capable of transmitting white light comprises the following steps:
transparent plastics, a blue pigment and a purple pigment are mixed (0.5-8 parts of the blue pigment and 0-2 parts of the purple pigment are added to 100 parts of the transparent plastics), and injection moulding is performed to form a transparent panel 1;
an indium plating layer 3 is formed on one side of a transparent panel 1 by PVD evaporation indium plating; and
the indium plating layer 3 is coated with a transparent coating to form a transparent coating layer 4, such that the composite film layer capable of transmitting white light is obtained.

The transparent plastics is, for example, polycarbonate, PVC, PET or PP transparent plastics.

The transparent coating forming the transparent coating layer is a mixture mainly prepared from transparent liquid epoxy resin or acrylic resin, can be used for various coating operations, and can be cross-linked to a layer in contact with the transparent coating after being cured, to protect a wrapping layer inside.

The indium plating layer is coated with the transparent coating by, but not limited to, spraying, transfer printing, screen printing, curtain coating, painting, and other coating methods.

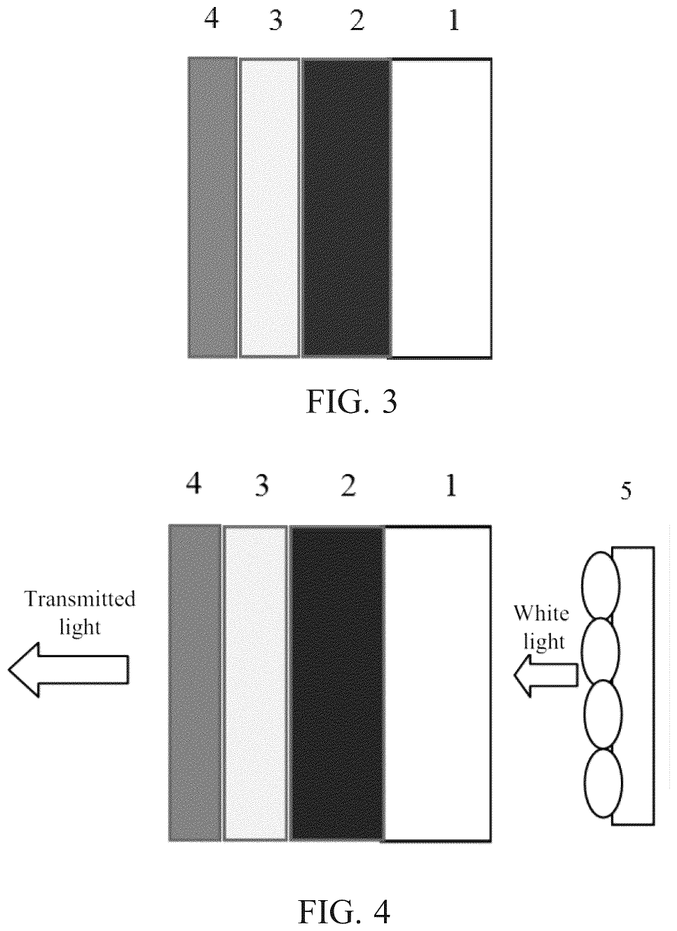

In some other embodiments of the invention, the composite film layer capable of transmitting white light, as shown in FIG. 3, sequentially comprises a transparent panel 1, a transparent priming layer 2, an indium plating layer 3 and a transparent coating layer 4, wherein the transparent panel 1 is closer to a white light source relative to the indium plating layer 3, and white light emitted by the white light source sequentially passes through the transparent panel 1, the transparent priming layer 2, the indium plating layer 3 and the transparent coating layer 4.

The thickness of the transparent panel 1, the thickness of the transparent priming layer 2, the thickness of the indium plating layer 3 and the thickness of the transparent coating layer 4 are 1 to 10 mm, 15 to 30 μm, 15 to 50 nm and 15 to 30 μm respectively.

The preparation method for the composite film layer capable of transmitting white light comprises the following steps:
transparent plastics, a blue pigment and a purple pigment are mixed (0.5-8 parts of the blue pigment and 0-2 parts of the purple pigment are added to 100 parts of the transparent plastics), and injection moulding is performed to form a transparent panel 1;
one side of the transparent panel 1 is coated with a transparent priming paste to form a transparent priming layer 2;
an indium plating layer 3 is formed on the transparent priming layer 2 by PVD evaporation indium plating; and
the indium plating layer 3 is coated with a transparent coating to form a transparent coating layer 4, such that the composite film layer capable of transmitting white light is obtained.

Before PVD evaporation indium plating, the transparent panel 1 is coated with a layer of the transparent priming paste by, but not limited to, spraying, transfer printing, screen printing, curtain coating, painting, and other coating methods. The transparent priming paste is a mixture mainly prepared from transparent liquid epoxy resin or acrylic resin, can be used for various coating operations, and can be cross-linked to the transparent panel and the indium plating layer after being cured, such that the adhesion of the transparent panel and the indium plating layer is improved, and the metal texture and test performance of the indium plating layer are improved. The transparent priming paste and the transparent coating comprise the same resin and are different in some additives.

In some other embodiments of the invention, a luminous device is provided, comprising a white light source and the composite film layer capable of transmitting white light. For example, in a case where the composite film layer capable of transmitting white light sequentially comprises a transparent panel, a transparent priming layer, an indium plating layer and a transparent coating layer, the luminous device, as shown in FIG. 4, comprises a white light source 5, the transparent panel 1, the transparent priming layer 2, the indium plating layer 3 and the transparent coating layer 4, white light emitted by the white light source 5 sequentially passes through the transparent panel 1, the transparent priming layer 2, the indium plating layer 3 and the transparent coating layer 4, and colour coordinates of transmitted light are within a range defined by six colour coordinate lines: A (0.310, 0.348), B (0.453, 0.440), C (0.500, 0.440), D (0.500, 0.382), E (0.443, 0.382), and F (0.310, 0.283),
and a colour temperature value of the transmitted light is 5200 to 7200 K.

The technical solutions of the invention are described in further detail below with reference to specific embodiments. It should be understood that the specific embodiments described here are merely used to help understand the invention and should not be construed as specific limitations of the invention. Unless otherwise specifically stated, raw materials in the embodiments of the invention are all common raw materials in the art, and methods adopted in the embodiments are all conventional methods in the art.

In the following embodiments, the transparent priming paste is VB3390U produced by Fujikura in Japan, and the transparent coating is VT3391U produced by Fujikura in Japan.

### Embodiment 1

In this embodiment, the preparation method for the composite film layer capable of transmitting white light specifically comprises the following steps:
100 parts of transparent polycarbonate plastics and 4 parts of a sky blue pigment with a CMYK value of C45 M10 Y10 K0 (an average particle size of 300 nm) were evenly mixed, and injection moulding was performed to form a transparent panel with a thickness of 5 mm;
a PVD indium plating layer with a thickness of 18 nm was formed on one side of the transparent panel by PVD evaporation indium plating; and
a transparent coating was sprayed onto the PVD indium plating layer and then cured to form a transparent coating layer with a thickness of 20 μm, such that the composite film layer capable of transmitting white light was obtained.

### Embodiment 2

In this embodiment, the preparation method for the composite film layer capable of transmitting white light specifically comprises the following steps:
100 parts of transparent polycarbonate plastics, 3 parts of a sky blue pigment with a CMYK value of C70 M10 Y0 K0 (an average particle size of 500 nm) and 0.5 parts of a dark reddish purple pigment with a CMYK value of C45 M70 Y50 K0 (an average particle size of 400 nm) were evenly mixed, and injection moulding was performed to form a transparent panel with a thickness of 7 mm;
a transparent priming paste was sprayed onto one side of the transparent panel and cured to form a transparent priming layer with a thickness of 20 μm;
a PVD indium plating layer with a thickness of 25 nm was formed on transparent priming layer by PVD evaporation indium plating; and
a transparent coating was sprayed onto the PVD indium plating layer and then cured to form a transparent coating layer with a thickness of 25 μm, such that the composite film layer capable of transmitting white light was obtained.

### Comparative Example 1

Comparative Example 1 is different from Embodiment 2 in that the blue pigment and the dark reddish purple pigment were not added to the transparent polycarbonate plastics in Comparative Example 1.

The composite film layers capable of transmitting white light in Embodiments 1-2 and Comparative Example 1 were illuminated with white light with a colour temperature of 6300 K emitted by a white light source, and colour coordinate and temperature data of transmitted light were tested by means of an LMK imaging luminance meter. Test results are shown in Table 1.

TABLE 1
Colour coordinate and temperature data of transmitted light

| | | | | Whether the | |
|---|---|---|---|---|---|
| | | | | coordinates | Whether the |
| | | | | are within | colour |
| | | | | the colour | temperature |
| | | | | coordinate | is within |
| | X (colour | Y (colour | T | range of | 5200-7200 |
| | coordinate) | coordinate) | (temperature)/K | white light | K |
| Embodiment 1 | 0.3426 | 0.3414 | 6660 | Yes | Yes |
| Embodiment 2 | 0.3502 | 0.3346 | 6827 | Yes | Yes |
| Comparative | 0.3682 | 0.4111 | 3923 | No | No |
| Example 1 | | | | | |

### Embodiment 3

The composite film layer capable of transmitting white light in Embodiment 2 was combined with a white light source to prepare an automotive luminous device.

In a case where the white light source was not turned on, the automotive luminous device (sign) showed a good metal effect as seen by human eyes. In a case where the white light source was turned on, white light passed through the automotive luminous device (sign), and light transmitted by the automotive luminous device was white as seen by human eyes. Colour coordinate and temperature data of transmitted light tested by means of an LMK imaging luminance meter indicated that the colour coordinates of light transmitted by the automotive luminous device were within the colour coordinate range of white light and the colour temperature of the light transmitted by the automotive luminous device was within 5200-7200 K.

### Comparative Example 2

The composite film layer capable of transmitting white light in Comparative Example 1 was combined with a white light source to prepare an automotive luminous device.

In a case where the white light source was not turned on, the automotive luminous device showed a good metal effect as seen by human eyes. In a case where the white light source was turned on, white light passed through the automotive luminous device (sign), and light transmitted by the automotive luminous device was yellow as seen by human eyes. Colour coordinate and temperature data of transmitted light tested by means of an LMK imaging luminance meter indicated that the colour coordinates of light transmitted by the automotive luminous device were not within the colour coordinate range of white light and the colour temperature of the light transmitted by the automotive luminous device was not within 5200-7200 K.

Finally, it should be noted that the specific embodiments described here are merely used for explaining the spirit of the invention by way of examples and are not intended to limit implementations of the invention. Those skilled in the art can make various amendments, supplements or similar substitutions to the embodiments described here, and it is impossible to enumerate all embodiments of the invention. These obvious modifications or transformations derived from the essential spirit of the invention should also fall within the protection scope of the invention, and it is against with the spirit of the invention to interpret these modifications or transformations as any additional limitations.

What is claimed is:

1. A composite film layer capable of transmitting white light, comprising a transparent panel and an indium plating layer, wherein the transparent panel is closer to a white light source relative to the indium plating layer;
the transparent panel is formed by mixing transparent plastics and a blue pigment and performing injection moulding.

2. The composite film layer capable of transmitting white light according to claim 1, wherein the mass of the blue pigment is 0.5-8% of the mass of the transparent plastics.

3. The composite film layer capable of transmitting white light according to claim 1, wherein the transparent panel is formed by mixing transparent plastics, a blue pigment and a purple pigment and performing injection moulding.

4. The composite film layer capable of transmitting white light according to claim 3, wherein the mass of the blue pigment is 0.5-8% of the mass of the transparent plastics, and the mass of the purple pigment is greater than 0% and less than or equal to 2% of the mass of the transparent plastics.

5. The composite film layer capable of transmitting white light according to claim 3, wherein an average particle size of the blue pigment and the purple pigment is 0.15 to 1.5 μm.

6. The composite film layer capable of transmitting white light according to claim 3, wherein a CMYK value of the blue pigment is one or more selecting from:
C35 M0 Y20 K0, C40 M0 Y10 K0, C60 M0 Y10 K0, C70 M10 Y0 K0, C45 M10 Y10 K0, C30 M0 Y10 K10, C40 M10 Y0 K20, C60 M15 Y0 K30, C75 M30 Y10 K15, C80 M10 Y20 K0, C95 M25 Y45 K0, C100 M50 Y45 K0, C100 M35 Y10 K0, C95 M60 Y0 K0, C100 M80 Y0 K0, and C90 M70 Y0 K0;
a CMYK value of the purple pigment is one or more selected from:
C55 M85 Y0 K0, C45 M70 Y50 K0, and C60 M95 Y95 K20.

7. The composite film layer capable of transmitting white light according to claim 1, wherein the composite film layer capable of transmitting white light sequentially comprises the transparent panel, the indium plating layer and a transparent coating layer.

8. The composite film layer capable of transmitting white light according to claim 7, wherein a thickness of the transparent panel, a thickness of the indium plating layer and a thickness of the transparent coating layer are 1 to 10 mm, 15 to 50 nm and 15 to 30 μm respectively.

9. The composite film layer capable of transmitting white light according to claim 1, wherein the composite film layer capable of transmitting white light sequentially comprises the transparent panel, a transparent priming layer, the indium plating layer and a transparent coating layer.

10. The composite film layer capable of transmitting white light according to claim 9, wherein a thickness of the transparent panel, a thickness of the transparent priming layer, a thickness of the indium plating layer and a thickness of the transparent coating layer are 1 to 10 mm, 15 to 30 μm, 15 to 50 nm and 15 to 30 μm respectively.

11. The composite film layer capable of transmitting white light according to claim 1, wherein when the white light source illuminates the composite film layer capable of transmitting white light, colour coordinates of transmitted light are within a range defined by six colour coordinate lines:
A (0.310, 0.348), B (0.453, 0.440), C (0.500, 0.440), D (0.500, 0.382), E (0.443, 0.382), and F (0.310, 0.283),
and a colour temperature value of the transmitted light is 5200 to 7200 K.

12. A preparation method for the composite film layer capable of transmitting white light according to claim 9, comprising the following steps:
mixing transparent plastics and a blue pigment, and performing injection moulding to form a transparent panel;
coating a side of the transparent panel with a transparent priming paste to form a transparent priming layer;
forming an indium plating layer on the transparent priming layer by PVD evaporation indium plating; and
coating the indium plating layer with a transparent coating to form a transparent coating layer, thus obtaining the composite film layer capable of transmitting white light.

13. A light-emitting device, comprising a white light source and the composite film layer capable of transmitting white light according to claim 1, wherein the transparent panel in the composite film layer capable of transmitting white light is closer to the white light source relative to the indium plating layer, and after white light emitted by the white light source passes through the composite film layer capable of transmitting white light, colour coordinates of transmitted light are within a range defined by six colour coordinate lines:
A (0.310, 0.348), B (0.453, 0.440), C (0.500, 0.440), D (0.500, 0.382), E (0.443, 0.382), and F (0.310, 0.283),
and a colour temperature value of the transmitted light is 5200 to 7200 K.
